(19) United States
(12) Patent Application Publication
(10) Pub. No.: US 2025/0371365 A1
(43) Pub. Date: Dec. 4, 2025

(54) METHOD FOR DETERMINING TRAINING DATA SET OF LARGE REWARD MODEL, AND ELECTRONIC DEVICE

(71) Applicant: BEIJING BAIDU NETCOM SCIENCE TECHNOLOGY CO., LTD., Beijing (CN)

(72) Inventors: Siyu Ding, Beijing (CN); Weichong Yin, Beijing (CN); Yu Sun, Beijing (CN); Hao Tian, Beijing (CN); Hua Wu, Beijing (CN); Haifeng Wang, Beijing (CN)

(73) Assignee: BEIJING BAIDU NETCOM SCIENCE TECHNOLOGY CO., LTD., Beijing (CN)

(21) Appl. No.: 18/967,376

(22) Filed: Dec. 3, 2024

(30) Foreign Application Priority Data
May 29, 2024 (CN) 202410680096.4

(51) Int. Cl. G06N 3/092; G06F 40/279; G06F 40/40

(52) U.S. Cl. CPC G06N 3/092; G06F 40/279; G06F 40/40

(57) ABSTRACT

The present disclosure provides a method and an apparatus for determining a training data set of a large reward model, and an electronic device, which relates to the technical field of artificial intelligence, and in particular to the technical fields of deep learning, natural language processing, and large models etc. The specific implementation includes: obtaining a candidate question text, and an answer requirement corresponding to the candidate question text; determining, based on the candidate question text and the answer requirement corresponding to the candidate question text, at least one candidate answer text corresponding to the candidate question text and scoring data of the at least one candidate answer text; selecting, based on the scoring data of the at least one candidate answer text, a target answer text from the at least one candidate answer text; and constructing, based on scoring data of the target answer text and a candidate question text corresponding to the target answer text, the training data set of the large reward model, for training the large reward model. The training data set that is configured for training the large reward model is generated by the electronic device based on the candidate question text and the corresponding answer requirement, resulting in the high accuracy. Thus, the accuracy and generalization of the trained large reward model are improved, and the accuracy of the dialogue model obtained by reinforcement learning based on the large reward model is also improved.

### CROSS-REFERENCE TO RELATED APPLICATION

The present application is based upon and claims priority to Chinese Patent Application No. 2024106800964, filed on May 29, 2024, the entire contents of which are incorporated herein by reference.

### TECHNICAL FIELD

The disclosure relates to the technical field of artificial intelligence, in particular to the technical fields of deep learning, natural language processing, and large models etc., and in particular to a method and an apparatus for determining a training data set of a large reward model, and an electronic device.

### BACKGROUND

At present, in task-oriented dialogue generation technologies based on a dialogue model, reinforcement learning is applied to the dialogue model based on the reward model. A training data set configured for training the reward model is obtained by manual annotation, and the annotation accuracy is poor, leading to accuracy and generalization problems of the obtained reward model. Thus, the dialog model may suffer from reward optimization during the reinforcement learning, which reduces the accuracy of the obtained dialog model.

### SUMMARY

According to a first aspect of the disclosure, a method for determining a training data set of a large reward model is provided. The method includes: obtaining a candidate question text, and an answer requirement corresponding to the candidate question text; determining, based on the candidate question text and the answer requirement corresponding to the candidate question text, at least one candidate answer text corresponding to the candidate question text and scoring data of the at least one candidate answer text; selecting, based on the scoring data of the at least one candidate answer text, a target answer text from the at least one candidate answer text; and constructing, based on scoring data of the target answer text and a candidate question text corresponding to the target answer text, the training data set of the large reward model, for training the large reward model.

According to another aspect of the disclosure, an electronic device is provided. The electronic device includes at least one processor; and a memory communicatively coupled to the at least one processor and storing instructions executable by the at least one processor; in which when the instructions are executed by the at least one processor, the at least one processor is caused to perform the above method according to the first aspect.

According to another aspect of the disclosure, a non-transitory computer readable storage medium is provided, which stores computer instructions. The computer instructions are used to enable a computer to perform the above method according to the first aspect.

### BRIEF DESCRIPTION OF THE DRAWINGS

The accompanying drawings are used for a better understanding of the disclosure and do not constitute a limitation of the disclosure.

FIG. 1 is a schematic diagram according to a first embodiment of the disclosure.

FIG. 2 is a schematic diagram according to a second embodiment of the disclosure.

FIG. 3 is a schematic diagram according to a third embodiment of the disclosure.

FIG. 4 is a schematic diagram according to a fourth embodiment of the disclosure.

FIG. 5 is a block diagram of an electronic device configured to implement a method for determining a training data set of a large reward model according to an embodiment of the disclosure.

### DETAILED DESCRIPTION

Exemplary embodiments of the disclosure are described hereinafter in conjunction with the accompanying drawings, which include various details of the embodiments of the disclosure in order to aid in understanding, and should be considered exemplary only. Accordingly, one of ordinary skill in the art should recognize that various changes and modifications can be made to the embodiments described herein without departing from the scope of the disclosure. Similarly, descriptions of well-known features and structures are omitted from the following description for the sake of clarity and brevity.

At present, in task-oriented dialogue generation technologies based on a dialogue model, reinforcement learning is applied to the dialogue model based on the reward model. A training data set configured for training the reward model is obtained by manual annotation, and the annotation accuracy is poor, leading to accuracy and generalization problems of the obtained reward model. Thus, the dialog model may suffer from reward optimization during the reinforcement learning, which reduces the accuracy of the obtained dialog model.

In view of the above problems, a method and an apparatus for determining a training data set of a large reward model, and an electronic device are provided in the disclosure.

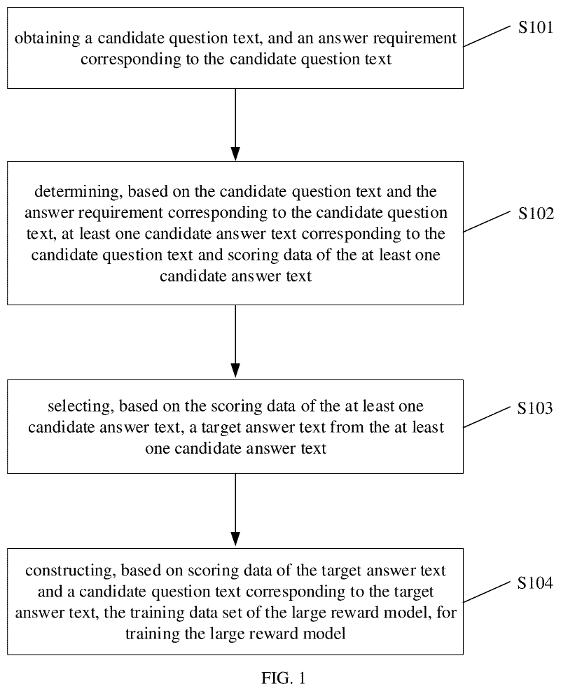

FIG. 1 is a schematic diagram according to a first embodiment of the disclosure. It should be noted that the method for determining a training data set of a large reward model of embodiments of the disclosure may be applied to the apparatus for determining a training data set of a large reward model. The apparatus may be configured in an electronic device to enable the electronic device to perform a function of determining the training data set of the large reward model. The following embodiments are illustrated with the execution subject being the electronic device.

The electronic device may be any device having computing power, which may be, for example, a personal computer (PC), a mobile terminal, a server, etc. The mobile terminal may, for example, be a hardware device having various operating systems, touch screens, and/or displays, such as an in-vehicle/vehicle-mounted device, a cellular phone, a tablet computer, a personal digital assistant, a wearable device, a smart speaker, a server, a server cluster, etc. In the following embodiments, the apparatus for determining a training data set of a large reward model is illustrated as an example of the electronic device.

As shown in FIG. 1, the method for determining a training data set of a large reward model may include the following steps 101 to 104.

At step 101, a candidate question text, and an answer requirement corresponding to the candidate question text are obtained.

In an embodiment of the disclosure, for the same candidate question text, different objects may give different answers or different objects may require different answers. The differences in the answers reflect the differences in the preferences of the objects. Thus, the answer requirement corresponding to the candidate question text can be determined based on preference data of the object. A specific answer requirement corresponding to the candidate question text can be obtained by selecting from at least one answer requirement of the object.

The preference data includes, for example, search preferences, content preferences and shopping preferences etc. For one candidate question text, a plurality of answer texts can be given.

The answer requirement corresponding to the candidate question text refers to the specific requirement of the candidate question text on the answer, i.e., what requirements the answer text should meet.

For example, if the candidate question text is “Who is Emperor Qin Shi Huang”, for some objects, their requirements are that the answer text needs to include the name of Emperor Qin Shi Huang; for some objects, their requirements are that the answer text needs to include both the name and the deeds of Emperor Qin Shi Huang; for some objects, their requirements are that the answer text needs to include both the name and the biography of Emperor Qin Shi Huang; and for some objects, their requirements are that the answer text needs to include the character of Emperor

### Qin Shi Huang.

The answer requirement corresponding to the candidate question text is determined based on the preference data of the object, and the answer text corresponding to the candidate question text is then determined. This ensures that the determined answer text can reflect the preferences of the object, which enables the constructed training data set to reflect the preferences of the object. Thus, the large reward model trained based on the training data set can reflect the preferences of the object, and the accuracy of the trained large reward model is improved.

At step 102, at least one candidate answer text corresponding to the candidate question text and scoring data of the at least one candidate answer text are determined based on the candidate question text and the answer requirement corresponding to the candidate question text.

In embodiments of the disclosure, the scoring data of the candidate answer text includes, for example, a correlation, a match degree, etc., between the candidate question text and the candidate answer text. The scoring data of the candidate answer text further includes, for example, a correlation, a match degree, etc., between the candidate answer text and the answer requirement corresponding to the candidate question text. The scoring data can be set according to actual needs.

At step 103, a target answer text is selected from the at least one candidate answer text based on the scoring data of the at least one candidate answer text.

In an embodiment of the disclosure, the scoring data may, for example, be a scoring value etc. Accordingly, the process of performing the step 103 by the electronic device may, for example, include: selecting a maximum scoring value from at least one scoring value; determining whether the maximum scoring value is greater than or equal to a preset scoring threshold; in response to the maximum scoring value being greater than or equal to the preset scoring threshold, determining a candidate answer text corresponding to the maximum scoring value as the target answer text; and in response to the maximum scoring value being less than the preset scoring threshold, determining that no target answer text exists in the at least one candidate answer text, i.e., no target answer text is obtained by selection.

Further, the electronic device may further perform the following process: in response to not obtaining the target answer text by selection, repeating the step of determining, based on the candidate question text and the answer requirement corresponding to the candidate question text, the candidate answer text, and the step of selecting the target answer text.

In response to not obtaining the target answer text by selection, the step of determining the candidate answer text and the step of selecting the target answer text are repeated, to perform the step of selecting the target answer text. This ensures that the accuracy of the determined target answer text can be improved, and the accuracy of the constructed training data set can be improved.

At step 104, the training data set of the large reward model is constructed based on scoring data of the target answer text and a candidate question text corresponding to the target answer text, for training the large reward model.

The large reward model refers to a reward model as a large model. The large model refers to a neural network model with a large number of parameters and a complex model structure. That is, the large reward model refers to a reward model with a large number of parameters and a complex model structure.

In an embodiment of the disclosure, the process of performing the step 104 by the electronic device may, for example, include: obtaining a historical training data set of the large reward model;

and obtaining the training data set of the large reward model, by adding the scoring data of the target answer text and the candidate question text corresponding to the target answer text into the historical training data set.

The historical training data set of the large reward model may be a training data set that has been used for training the large reward model. The method for obtaining a historical answer text corresponding to a historical question text in the historical training data set may, for example, include at least one of: generating by a question-and-answer (Q&A) dialog model, searching in a knowledge base, or capturing from a dialog process, etc. The method for obtaining scoring data for the historical answer text in the historical training data set may, for example, include at least one of: determining based on a similarity between the historical answer text and the historical question text, determining based on a number of occurrences or a frequency of occurrences of a Q&A pair of the historical answer text and the historical question text in the knowledge base, or labeling, etc.

The real-time supplementation of the training data set can improve the accuracy of the training data set, thus further improving the accuracy of the trained large reward model.

In an embodiment of the disclosure, the electronic device may further perform the following process: in response to the candidate question text being a historical question text in the historical training data set of the large reward model, replacing a historical answer text corresponding to the candidate question text and scoring data of the historical answer text in the historical training data set, based on the target answer text and the scoring data of the target answer text.

The repair of the training data set can further improve the accuracy of the training data set, thus further improving the accuracy of the trained large reward model.

In an embodiment of the disclosure, after the step 104, the electronic device may further perform the following processes: obtaining an initial large reward model; obtaining a trained large reward model by training the initial large reward model based on the training data set; and training an initial dialog model based on the trained large reward model and a training dialog data set.

The training process of the large reward model by the electronic device may, for example, include: obtaining predicted scoring data output by the large reward model, by inputting a sample question text and a sample answer text in the training data set into the large reward model; determining a value of a loss function of the large reward model based on scoring data of the sample answer text and the predicted scoring data of the sample answer text; and obtaining a trained large reward model by adjusting a parameter of the large reward model based on the value of the loss function.

The training dialog data set may include a sample dialog question. Accordingly, the training process of the dialog model by the electronic device may, for example, include: obtaining a predicted dialog answer output by the initial dialog model, by inputting the sample dialog question in the training dialog data set into the initial dialog model; obtaining predicted scoring data output by the large reward model, by inputting the sample dialog question and the predicted dialog answer into the large reward model; determining a value of a loss function of the dialog model based on the predicted scoring data; and performing training by adjusting a parameter of the dialog model based on the value of the loss function.

It should be noted that the initial dialog model may be a pre-trained dialog model; or, the initial dialog model may be a pre-trained and fine-tuned dialog model.

The electronic device trains the large reward model based on the determined training data set; and trains the dialog model based on the trained large reward model. Thus, the accuracy of the trained large reward model is improved, and the accuracy of the trained dialogue model is also improved.

According to the method for determining a training data set of a large reward model provided in embodiments of the disclosure, the candidate question text, and the answer requirement corresponding to the candidate question text are obtained; the at least one candidate answer text corresponding to the candidate question text and the scoring data of the at least one candidate answer text are determined based on the candidate question text and the answer requirement corresponding to the candidate question text; the target answer text is selected from the at least one candidate answer text based on the scoring data of the at least one candidate answer text; and the training data set of the large reward model is constructed based on scoring data of the target answer text and the candidate question text corresponding to the target answer text, for training the large reward model. The training data set that is configured for training the large reward model is generated by the electronic device based on the candidate question text and the corresponding answer requirement, resulting in the high accuracy. Thus, the accuracy and generalization of the trained large reward model are improved, and the accuracy of the dialogue model obtained by reinforcement learning based on the large reward model is also improved.

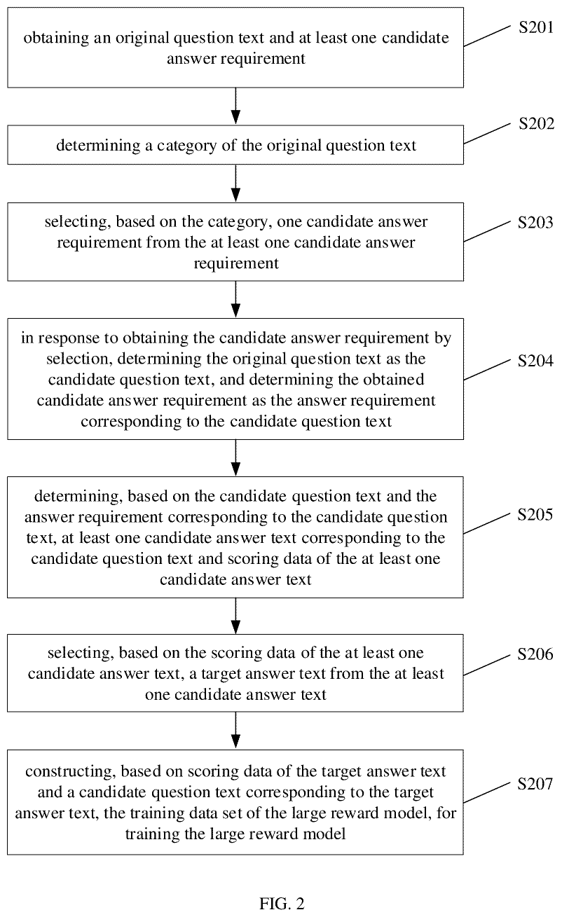

The electronic device may obtain an original question text and at least one candidate answer requirement, select one candidate answer requirement from the at least one candidate answer requirement based on a category of the original question text, and determine the candidate question text and a corresponding answer requirement. Thus, a match degree between the candidate question text and the corresponding answer requirement is ensured. As shown in FIG. 2, it is a schematic diagram according to a second embodiment of the disclosure. The embodiments shown in FIG. 2 may include the following steps 201 to 207.

At step 201, an original question text and at least one candidate answer requirement are obtained.

In an embodiment of the disclosure, the method for obtaining the original question text may include at least one of: capturing from a web page text, or extracting from a dialog log, etc.

The at least one candidate answer requirement may be determined based on the preference data of the object. A specific answer requirement corresponding to the candidate question text can be obtained by selecting from at least one answer requirement of the object.

At step 202, a category of the original question text is determined.

In an embodiment of the disclosure, the process of performing the step 202 by the electronic device may, for example, include: obtaining a category output by a classification model, by inputting the original question text into the classification model. The category of the original question text may refer to a field to which the original question text belongs and/or a Q&A type of the original question text. The field to which the original question text belongs may be, for example, a communication field, a biological field, or a modeling field, etc., which can be set according to actual needs. Further, the field to which the original question text belongs may be a subfield of one of the various fields described above.

The Q&A type of the original question text include, for example, a knowledge Q&A type, a translation type, a selection type, or a determination type, etc.

In the case that the category of the original question text refers to the field to which the original question text belongs and the Q&A type of the original question text, the category may be, for example, a Q&A type in the communication field, a translation type in the communication field, a selection type in the biological field, or a determination type in the modeling field, etc., which can be set according to actual needs.

At step 203, one candidate answer requirement is selected from the at least one candidate answer requirement based on the category.

In an embodiment of the disclosure, the process of performing the step 203 by the electronic device may, for example, include: determining a correlation between the category and the at least one candidate answer requirement; and selecting a candidate answer requirement with a corresponding correlation greater than or equal to a correlation threshold.

In an embodiment, a correlation between the category and the candidate answering requirement may be obtained by determining a semantic similarity between the category and the candidate answering requirement. The semantic similarity refers to a feature similarity between a semantic feature of the category and a semantic feature of the candidate answer requirement.

In another embodiment, the process of determining the correlation between the category and the candidate answering requirement by the electronic device may, for example, include: obtaining, by the electronic device, a correlation output by a correlation model, by inputting the category and the candidate answer requirement into the correlation model; and determining the outputted correlation as the correlation between the category and the candidate answering requirement.

The candidate answer requirement is selected based on the correlation between the category and the at least one candidate answer requirement; and the candidate question text and the corresponding answer requirement are determined. Thus, a match degree between the candidate question text and the corresponding answer requirement may be improved.

At step 204, in response to obtaining the candidate answer requirement by selection, the original question text is determined as the candidate question text, and the obtained candidate answer requirement is determined as the answer requirement corresponding to the candidate question text.

In an embodiment of the disclosure, as an alternative to steps 201 to 204, the electronic device may perform the following process: obtaining an original question text and at least one candidate answer requirement; determining a correlation between the original question text and the at least one candidate answer requirement; selecting, based on the correlation, one candidate answer requirement from the at least one candidate answer requirement; and in response to obtaining the candidate answer requirement by selection, determining the original question text as the candidate question text, and determining the obtained candidate answer requirement as the answer requirement corresponding to the candidate question text.

The process of selecting, based on the correlation, the one candidate answer requirement from the at least one candidate answer requirement by the electronic device based on the correlation may, for example, include: determining a candidate answer requirement with a corresponding correlation greater than or equal to a preset correlation threshold as the candidate answer requirement obtained by the selection (i.e., the above obtained candidate answer requirement). If the correlation between each of the at least one candidate answer requirement and the original question text is less than the preset correlation threshold, it is determined that the candidate answer requirement is not obtained by selection.

In an embodiment of the disclosure, the process of determining the correlation between the original question text and the at least one candidate answer requirement by the electronic device may, for example, include: for each candidate answer requirement to be processed in the at least one candidate answer requirement, obtaining a correlation output by a correlation classification model, by inputting the original question text and the candidate answer requirement to be processed into the correlation classification model; and determining the correlation output by the correlation classification model as a correlation between the original question text and the candidate answer requirement to be processed.

The electronic device selects the one candidate answer requirement from the at least one candidate answer requirement based on the correlation between the original question text and the at least one candidate answer requirement, and determines the candidate question text and a corresponding answer requirement. Thus, a match degree between the candidate question text and the corresponding answer requirement can be further ensured.

The use of the correlation classification model improves the accuracy of the determined correlation between the candidate answer requirement and the original question text. Thus, a match degree between the candidate question text and the corresponding answer requirement is further ensured.

Further, the electronic device may further perform the following process: in response to not obtaining the candidate answer requirement by selection, stopping the step of determining the original question text as the candidate question text. In the case that the candidate answer requirement is not obtained by selection, the step of determining the original question text as the candidate question text is stopped, thereby further improving the accuracy of the determined match degree between the candidate answer requirement and the original question text.

At step 205, at least one candidate answer text corresponding to the candidate question text and scoring data of the at least one candidate answer text are determined based on the candidate question text and the answer requirement corresponding to the candidate question text.

At step 206, a target answer text is selected from the at least one candidate answer text based on the scoring data of the at least one candidate answer text.

At step 207, the training data set of the large reward model is constructed based on scoring data of the target answer text and a candidate question text corresponding to the target answer text, for training the large reward model.

It should be noted that the details of steps 205 to 207 can be referred to the above steps 102 to 104 in the embodiments shown in FIG. 1, which will not be described in detail here.

According to the method for determining a training data set of a large reward model provided in embodiments of the disclosure, the original question text and the at least one candidate answer requirement are obtained; the category of the original question text is determined; the one candidate answer requirement is selected from the at least one candidate answer requirement based on the category; and in response to obtaining the candidate answer requirement by selection, the original question text is determined as the candidate question text, and the obtained candidate answer requirement is determined as the answer requirement corresponding to the candidate question text; the at least one candidate answer text corresponding to the candidate question text and the scoring data of the at least one candidate answer text are determined based on the candidate question text and the answer requirement corresponding to the candidate question text; the target answer text is selected from the at least one candidate answer text based on the scoring data of the at least one candidate answer text; and the training data set of the large reward model is constructed based on the scoring data of the target answer text and the candidate question text corresponding to the target answer text, for training the large reward model. The electronic device selects the one candidate answer requirement from the at least one candidate answer requirement based on the category of the original question text, and determines the candidate question text and the corresponding answer requirement. Thus, a match degree between the candidate question text and the corresponding answer requirement is ensured and the accuracy of the determined training data set is improved. The accuracy and generalization of the trained large reward model are improved, and the accuracy of the dialogue model obtained by reinforcement learning based on the large reward model is also improved.

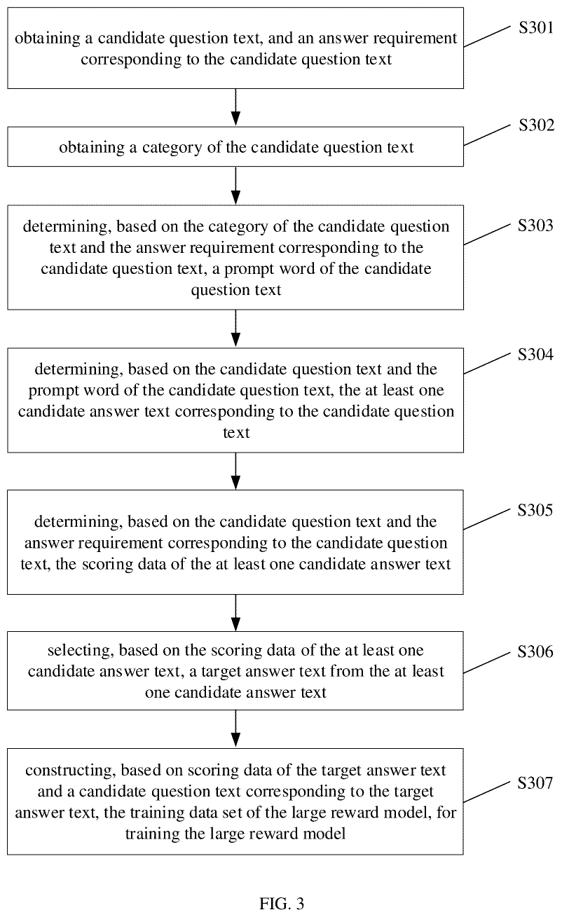

The electronic device may determine a prompt word of the candidate question text based on the category of the candidate question text and the answer requirement corresponding to the candidate question text, determine the at least one candidate answer text corresponding to the candidate question text based on the prompt word, and generate a candidate answer text matching the answer requirement. Thus, a match degree between the generated candidate answer text and the candidate question text is improved. As shown in FIG. 3, it is a schematic diagram according to a third embodiment of the disclosure. The embodiments shown in FIG. 3 may include the following steps 301 to 307.

At step 301, a candidate question text, and an answer requirement corresponding to the candidate question text are obtained.

At step 302, a category of the candidate question text is obtained.

At step 303, a prompt word of the candidate question text is determined based on the category of the candidate question text and the answer requirement corresponding to the candidate question text.

In an embodiment of the disclosure, the process of performing the step 303 by the electronic device may, for example, include: obtaining a prompt word output by a prompt word generation model, by inputting the category of the candidate question text and the answer requirement corresponding to the candidate question text into the prompt word generation model; and determining the prompt word output by the prompt word generation model as the prompt word of the candidate question text.

The prompt word generation model may be configured to generate a prompt word that includes the category of the candidate question text and the answer requirement corresponding to the candidate question text, or generate a prompt word that includes a keyword matching both the category and the answer requirement.

The electronic device generates the prompt word based on the category of the candidate question text, the answer requirement corresponding to the candidate question text, and the prompt word generation model. The prompt generation model has a large amount of computation and a high computational accuracy, which can improve the accuracy of the generated prompt word, thus improving the accuracy of the generated candidate answer text.

At step 304, the at least one candidate answer text corresponding to the candidate question text is determined based on the candidate question text and the prompt word of the candidate question text.

In an embodiment of the disclosure, the process of performing the step 304 by the electronic device may, for example, include: obtaining one candidate answer text output by an answer generation model, by inputting the candidate question text and the prompt word of the candidate question text into the answer generation model; and obtaining another candidate answer text output by the answer generation model, by inputting the candidate question text and the prompt word of the candidate question text into the answer generation model again. When a number of candidate answer texts being greater than two are needed, the above process is repeated, and the device obtains a desired number of candidate answer texts.

At step 305, the scoring data of the at least one candidate answer text is determined based on the candidate question text and the answer requirement corresponding to the candidate question text.

In an embodiment of the disclosure, the process of performing the step 305 by the electronic device may, for example, include: obtaining a ranking result of the at least one candidate answer text, by inputting the candidate question text, the answer requirement corresponding to the candidate question text, and the at least one candidate answer text into a ranking model; and determining, based on the ranking result, the scoring data of the at least one candidate answer text.

Before inputting the candidate question text, the answer requirement corresponding to the candidate question text, and the at least one candidate answer text into the ranking model, a number of candidate answer texts corresponding to the candidate question text may be determined. In the case of the number being 1, scoring data for the candidate answer text is determined based on the scoring model. In the case of the number being greater than or equal to 2, the electronic device obtains a ranking result of the plurality of candidate answer texts output by the ranking model, by inputting the candidate question text, the answer requirement corresponding to the candidate question text, and the plurality of candidate answer texts into the ranking model.

In the ranking result, candidate answer texts with higher scoring data are ranked at top, and candidate answer texts with lower scoring data are ranked at bottom. Thus, the scoring data of each candidate answer text can be determined based on a ranking order of each candidate answer text in the ranking result.

The scoring data of the at least one candidate answer text is determined based on the ranking model, the candidate question text, the answer requirement corresponding to the candidate question text, and the at least one candidate answer text. The ranking model has a large amount of computation and a high computational accuracy, which can improve the accuracy of the determined scoring data of the candidate answer text.

In another embodiment of the disclosure, the process of performing the step 305 by the electronic device may, for example, include: for each candidate answer text to be processed corresponding to the candidate question text, obtaining scoring data of the candidate answer text to be processed output by a scoring model, by inputting the candidate question text, the answer requirement corresponding to the candidate question text and the candidate answer text to be processed into the scoring model.

The scoring data of the at least one candidate answer text is determined based on the scoring model, the candidate question text, the answer requirement corresponding to the candidate question text, and the at least one candidate answer text. The scoring model has a large amount of computation and a high computational accuracy, which can improve the accuracy of the determined scoring data of the candidate answer text.

At step 306, a target answer text is selected from the at least one candidate answer text based on the scoring data of the at least one candidate answer text.

At step 307, the training data set of the large reward model is constructed based on scoring data of the target answer text and a candidate question text corresponding to the target answer text, for training the large reward model.

It should be noted that the details of step 301, step 306 to step 307 can be referred to the above step 101, step 103 to step 104 in the embodiments shown in FIG. 1, which will not be described in detail here.

According to the method for determining a training data set of a large reward model provided in embodiments of the disclosure, the candidate question text and the answer requirement corresponding to the candidate question text are obtained; the category of the candidate question text is obtained; the prompt word of the candidate question text is determined based on the category of the candidate question text and the answer requirement corresponding to the candidate question text; the at least one candidate answer text corresponding to the candidate question text is determined based on the candidate question text and the prompt word of the candidate question text; the scoring data of the at least one candidate answer text is determined based on the candidate question text and the answer requirement corresponding to the candidate question text; the target answer text is selected from the at least one candidate answer text based on the scoring data of the at least one candidate answer text; the training data set of the large reward model is constructed based on the scoring data of the target answer text and the candidate question text corresponding to the target answer text, for training the large reward model. The electronic device determines the prompt word of the candidate question text based on the category of the candidate question text and the answer requirement corresponding to the candidate question text, determines the at least one candidate answer text corresponding to the candidate question text based on the prompt word, and generates the candidate answer text matching the answer requirement. Thus, a match degree between the generated candidate answer text and the candidate question text is improved. The accuracy of the determined training data set is improved. The accuracy and generalization of the trained large reward model are improved, and the accuracy of the dialogue model obtained by reinforcement learning based on the large reward model is also improved.

To implement the above embodiments, an apparatus for determining a training data set of a large reward model is further provided in the disclosure. As shown in FIG. 4, it is a schematic diagram according to a fourth embodiment of the disclosure. The apparatus 40 for determining a training data set of a large reward model may include: a first obtaining module 401, a determining module 402, a selecting module 403, and a constructing module 404.

The first obtaining module 401 is configured to obtain a candidate question text, and an answer requirement corresponding to the candidate question text. The determining module 402 is configured to determine, based on the candidate question text and the answer requirement corresponding to the candidate question text, at least one candidate answer text corresponding to the candidate question text and scoring data of the at least one candidate answer text. The selecting module 403 is configured to select, based on the scoring data of the at least one candidate answer text, a target answer text from the at least one candidate answer text. The constructing module 404 is configured to construct, based on scoring data of the target answer text and a candidate question text corresponding to the target answer text, the training data set of the large reward model, for training the large reward model.

As a possible implementation of the embodiments of the disclosure, the first obtaining module 401 is specifically configured to obtain an original question text and at least one candidate answer requirement; determine a category of the original question text; select, based on the category, one candidate answer requirement from the at least one candidate answer requirement; and in response to obtaining the candidate answer requirement by selection, determine the original question text as the candidate question text, and determine the obtained candidate answer requirement as the answer requirement corresponding to the candidate question text.

As a possible implementation of the embodiments of the disclosure, the first obtaining module 401 is specifically further configured to determine a correlation between the category and the at least one candidate answer requirement; and select a candidate answer requirement with a corresponding correlation greater than or equal to a correlation threshold.

As a possible implementation of the embodiments of the disclosure, the first obtaining module 401 is specifically configured to obtain an original question text and at least one candidate answer requirement; determine a correlation between the original question text and the at least one candidate answer requirement; select, based on the correlation, one candidate answer requirement from the at least one candidate answer requirement; and in response to obtaining the candidate answer requirement by selection, determine the original question text as the candidate question text, and determine the obtained candidate answer requirement as the answer requirement corresponding to the candidate question text.

As a possible implementation of the embodiments of the disclosure, the first obtaining module 401 is specifically further configured to, for each candidate answer requirement to be processed in the at least one candidate answer requirement, obtain a correlation output by a correlation classification model, by inputting the original question text and the candidate answer requirement to be processed into the correlation classification model; and determine the correlation output by the correlation classification model as a correlation between the original question text and the candidate answer requirement to be processed.

As a possible implementation of the embodiments of the disclosure, the first obtaining module 401 is specifically further configured to, in response to not obtaining the candidate answer requirement by selection, stop the step of determining the original question text as the candidate question text.

As a possible implementation of the embodiments of the disclosure, the at least one candidate answer requirement is determined based on preference data of an object.

As a possible implementation of the embodiments of the disclosure, the determining module 402 includes an obtaining unit, a first determining unit, a second determining unit and a third determining unit. The obtaining unit is configured to obtain a category of the candidate question text. The first determining unit is configured to determine, based on the category of the candidate question text and the answer requirement corresponding to the candidate question text, a prompt word of the candidate question text. The second determining unit is configured to determine, based on the candidate question text and the prompt word of the candidate question text, the at least one candidate answer text corresponding to the candidate question text. The third determining unit is configured to determine, based on the candidate question text and the answer requirement corresponding to the candidate question text, the scoring data of the at least one candidate answer text.

As a possible implementation of the embodiments of the disclosure, the first determining unit is specifically configured to obtain a prompt word output by a prompt word generation model, by inputting the category of the candidate question text and the answer requirement corresponding to the candidate question text into the prompt word generation model; and determine the prompt word output by the prompt word generation model as the prompt word of the candidate question text.

As a possible implementation of the embodiments of the disclosure, the third determining unit is specifically configured to obtain a ranking result of the at least one candidate answer text, by inputting the candidate question text, the answer requirement corresponding to the candidate question text, and the at least one candidate answer text into a ranking model; and determine, based on the ranking result, the scoring data of the at least one candidate answer text.

As a possible implementation of the embodiments of the disclosure, the third determining unit is specifically configured to, for each candidate answer text to be processed corresponding to the candidate question text, obtain scoring data of the candidate answer text to be processed output by a scoring model, by inputting the candidate question text, the answer requirement corresponding to the candidate question text and the candidate answer text to be processed into the scoring model.

As a possible implementation of the embodiments of the disclosure, the apparatus further includes a repeating module, configured to, in response to not obtaining the target answer text by selection, repeat the step of determining, based on the candidate question text and the answer requirement corresponding to the candidate question text, the candidate answer text, and the step of selecting the target answer text.

As a possible implementation of the embodiments of the disclosure, the constructing module 404 is specifically configured to obtain the training data set of the large reward model; and obtain the training data set of the large reward model, by adding the scoring data of the target answer text and the candidate question text corresponding to the target answer text into the historical training data set.

As a possible implementation of the embodiments of the disclosure, the constructing module 404 is specifically configured to, in response to the candidate question text being a historical question text in the historical training data set of the large reward model, replace a historical answer text corresponding to the candidate question text and scoring data of the historical answer text in the historical training data set, based on the target answer text and the scoring data of the target answer text.

As a possible implementation of the embodiments of the disclosure, the apparatus further includes a second obtaining module, a first training module and a second training module. The second obtaining module is configured to obtain an initial large reward model. The first training module is configured to obtain a trained large reward model by training the initial large reward model based on the training data set. The second training module is configured to train an initial dialog model based on the trained large reward model and a training dialog data set.

As a possible implementation of the embodiments of the disclosure, the training dialog data set includes a sample dialog question. The second training module is configured to obtain a predicted dialog answer output by the initial dialog model, by inputting the sample dialog question in the training dialog data set into the initial dialog model; obtain predicted scoring data output by the large reward model, by inputting the sample dialog question and the predicted dialog answer into the large reward model; determine a value of a loss function of the initial dialog model based on the predicted scoring data; and perform training by adjusting a parameter of the initial dialog model based on the value of the loss function.

According to the apparatus for determining a training data set of a large reward model provided in embodiments of the disclosure, the candidate question text, and the answer requirement corresponding to the candidate question text are obtained; the at least one candidate answer text corresponding to the candidate question text and the scoring data of the at least one candidate answer text are determined based on the candidate question text and the answer requirement corresponding to the candidate question text; the target answer text is selected from the at least one candidate answer text based on the scoring data of the at least one candidate answer text; and the training data set of the large reward model is constructed based on scoring data of the target answer text and the candidate question text corresponding to the target answer text, for training the large reward model. The training data set that is configured for training the large reward model is generated by an electronic device based on the candidate question text and the corresponding answer requirement, resulting in the high accuracy. Thus, the accuracy and generalization of the trained large reward model are improved, and the accuracy of the dialogue model obtained by reinforcement learning based on the large reward model is also improved.

In the technical solution of the disclosure, the acquisition, storage, application, processing, transmission, provision and disclosure of the personal information of the users are all carried out under the premise of obtaining the consent of the users and are in compliance with relevant laws and regulations, and do not violate public order and morals.

According to embodiments of the disclosure, it also provides an electronic device, a readable storage medium, and a computer program product.

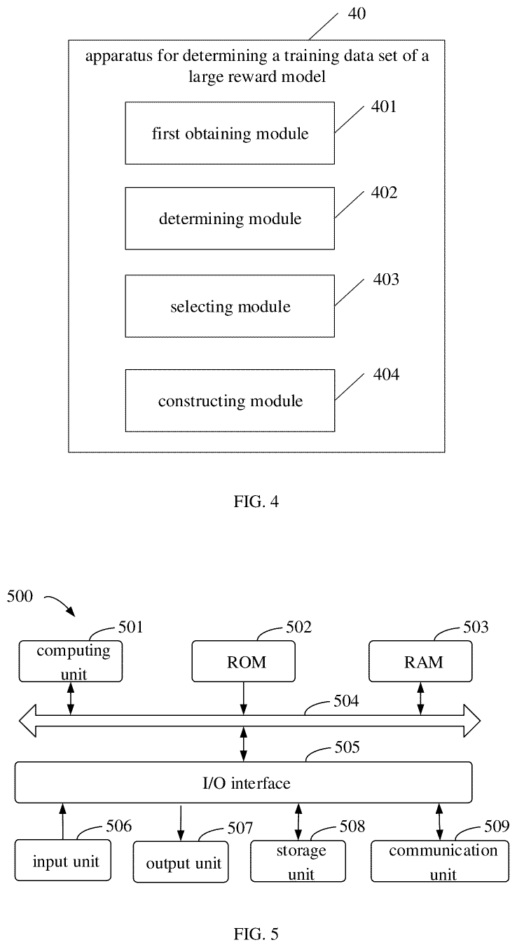

Referring to FIG. 5, it is a block diagram illustrating an electronic device 500 according to an embodiment of the disclosure. The electronic device is intended to represent various types of digital computers, such as laptop computers, desktop computers, workstations, personal digital assistants, servers, blade servers, mainframe computers, and other suitable computers. The electronic device may also represent various types of mobile devices, such as personal digital assistants, cellular phones, smart phones, wearable devices, and other similar computing devices. The components shown herein, their connections and relations, and their functions are merely examples, which are not intended to limit the implementations of the disclosure described and/or required herein.

As shown in FIG. 5, the device 500 includes a computing unit 501, configured to execute various appropriate actions and processes according to a computer program stored in a read-only memory (ROM) 502 or a computer program loaded from a storage unit 508 to a random access memory (RAM) 503. In the RAM 503, various programs and data required for the device 500 may be stored. The computing unit 501, the ROM 502 and the RAM 503 may be connected with each other by a bus 504. An input/output (I/O) interface 505 is also connected to the bus 504.

The plurality of components in the device 500 are connected to the I/O interface 505, which include: an input unit 506, for example, a keyboard, a mouse; an output unit 507, for example, various types of displays, speakers; a storage unit 508, for example, a magnetic disk, an optical disk; and a communication unit 509, for example, a network card, a modem, a wireless transceiver. The communication unit 509 allows the device 500 to exchange information/data through a computer network such as Internet and/or various types of telecommunication networks with other devices.

The computing unit 501 may be various types of general and/or dedicated processing components with processing and computing abilities. Some examples of a computing unit 501 include but not limited to a central processing unit (CPU), a graphics processing unit (GPU), various dedicated artificial intelligence (AI) computing chips, various computing units on which a machine learning model algorithm is running, a digital signal processor (DSP), and any appropriate processor, controller, microcontroller, etc. The computing unit 501 executes various methods and processes as described above, for example, a method for determining a training data set of a large reward model. For example, in some embodiments, the method for determining a training data set of a large reward model may be further implemented as a computer software program, which is tangibly contained in a machine readable medium, such as the storage unit 508. In some embodiments, a part or all of the computer program may be loaded and/or installed on the device 500 via the ROM 502 and/or the communication unit 509. When the computer program is loaded on the RAM 503 and executed by the computing unit 501, one or more steps in the method for determining a training data set of a large reward model may be performed as described above. Optionally, in other embodiments, the computing unit 501 may be configured to the method for determining a training data set of a large reward model in other appropriate ways (for example, by virtue of a firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided for the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAMs, ROMs, Electrically Programmable Read-Only-Memory (EPROM), fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: a Local Area Network (LAN), a Wide Area Network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, a server of a distributed system, or a server combined with a block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the principle of the disclosure shall be included in the protection scope of the disclosure.

What is claimed is:

1. A computer-implemented method for determining a training data set of a large reward model, comprising:
obtaining a candidate question text, and an answer requirement corresponding to the candidate question text;
determining, based on the candidate question text and the answer requirement corresponding to the candidate question text, at least one candidate answer text corresponding to the candidate question text and scoring data of the at least one candidate answer text;
selecting, based on the scoring data of the at least one candidate answer text, a target answer text from the at least one candidate answer text; and
constructing, based on scoring data of the target answer text and a candidate question text corresponding to the target answer text, the training data set of the large reward model, for training the large reward model.

2. The method according to claim 1, wherein obtaining the candidate question text, and the answer requirement corresponding to the candidate question text comprises:
obtaining an original question text and at least one candidate answer requirement;
determining a category of the original question text;
selecting, based on the category, one candidate answer requirement from the at least one candidate answer requirement; and
in response to obtaining the candidate answer requirement by selection, determining the original question text as the candidate question text, and determining the obtained candidate answer requirement as the answer requirement corresponding to the candidate question text.

3. The method according to claim 2, wherein selecting, based on the category, the one candidate answer requirement from the at least one candidate answer requirement comprises:
determining a correlation between the category and each of the at least one candidate answer requirement; and
selecting a candidate answer requirement with a corresponding correlation greater than or equal to a correlation threshold.

4. The method according to claim 1, wherein obtaining the candidate question text, and the answer requirement corresponding to the candidate question text comprises:
obtaining an original question text and at least one candidate answer requirement;
determining a correlation between the original question text and each of the at least one candidate answer requirement;
selecting, based on the correlation, one candidate answer requirement from the at least one candidate answer requirement; and
in response to obtaining the candidate answer requirement by selection, determining the original question text as the candidate question text, and determining the obtained candidate answer requirement as the answer requirement corresponding to the candidate question text.

5. The method according to claim 4, wherein determining the correlation between the original question text and each of the at least one candidate answer requirement comprises:
for each candidate answer requirement to be processed in the at least one candidate answer requirement,
obtaining a correlation output by a correlation classification model, by inputting the original question text and the candidate answer requirement to be processed into the correlation classification model; and
determining the correlation output by the correlation classification model as a correlation between the original question text and the candidate answer requirement to be processed.

6. The method according to claim 2, further comprising:
in response to not obtaining the candidate answer requirement by selection, stopping the step of determining the original question text as the candidate question text.

7. The method according to claim 4, further comprising:
in response to not obtaining the candidate answer requirement by selection, stopping the step of determining the original question text as the candidate question text.

8. The method according to claim 2, wherein the at least one candidate answer requirement is determined based on preference data of an object.

9. The method according to claim 4, wherein the at least one candidate answer requirement is determined based on preference data of an object.

10. The method according to claim 1, wherein determining the at least one candidate answer text corresponding to the candidate question text and the scoring data of the at least one candidate answer text comprises:
obtaining a category of the candidate question text;
determining, based on the category of the candidate question text and the answer requirement corresponding to the candidate question text, a prompt word of the candidate question text;
determining, based on the candidate question text and the prompt word of the candidate question text, the at least one candidate answer text corresponding to the candidate question text; and
determining, based on the candidate question text and the answer requirement corresponding to the candidate question text, the scoring data of the at least one candidate answer text.

11. The method according to claim 10, wherein determining the prompt word of the candidate question text comprises:
obtaining a prompt word output by a prompt word generation model, by inputting the category of the candidate question text and the answer requirement corresponding to the candidate question text into the prompt word generation model; and
determining the prompt word output by the prompt word generation model as the prompt word of the candidate question text.

12. The method according to claim 10, wherein determining the scoring data of the at least one candidate answer text comprises:
obtaining a ranking result of the at least one candidate answer text, by inputting the candidate question text, the answer requirement corresponding to the candidate question text, and the at least one candidate answer text into a ranking model; and
determining, based on the ranking result, the scoring data of the at least one candidate answer text.

13. The method according to claim 10, wherein determining the scoring data of the at least one candidate answer text comprises:
for each candidate answer text to be processed corresponding to the candidate question text, obtaining scoring data of the candidate answer text to be processed output by a scoring model, by inputting the candidate question text, the answer requirement corresponding to the candidate question text and the candidate answer text to be processed into the scoring model.

14. The method according to claim 1, further comprising:
in response to not obtaining the target answer text by selection, repeating the step of determining, based on the candidate question text and the answer requirement corresponding to the candidate question text, the candidate answer text, and the step of selecting the target answer text.

15. The method according to claim 1, wherein constructing the training data set of the large reward model comprises:
obtaining a historical training data set of the large reward model; and
obtaining the training data set of the large reward model, by adding the scoring data of the target answer text and the candidate question text corresponding to the target answer text into the historical training data set.

16. The method according to claim 15, wherein constructing the training data set of the large reward model comprises:
in response to the candidate question text being a historical question text in the historical training data set of the large reward model, replacing a historical answer text corresponding to the candidate question text and scoring data of the historical answer text in the historical training data set, with the target answer text and the scoring data of the target answer text.

17. The method according to claim 1, further comprising:
obtaining an initial large reward model;
obtaining a trained large reward model by training the initial large reward model based on the training data set; and
training an initial dialog model based on the trained large reward model and a training dialog data set.

18. The method according to claim 17, wherein the training dialog data set comprises a sample dialog question;
wherein training the initial dialog model comprises:
obtaining a predicted dialog answer output by the initial dialog model, by inputting the sample dialog question in the training dialog data set into the initial dialog model;
obtaining predicted scoring data output by the large reward model, by inputting the sample dialog question and the predicted dialog answer into the large reward model;
determining a value of a loss function of the initial dialog model based on the predicted scoring data; and
performing training by adjusting a parameter of the initial dialog model based on the value of the loss function.

19. An electronic device, comprising:
at least one processor; and
a memory communicatively coupled to the at least one processor and storing instructions executable by the at least one processor;
wherein when the instructions are executed by the at least one processor, the at least one processor is caused to obtain a candidate question text, and an answer requirement corresponding to the candidate question text;
determine, based on the candidate question text and the answer requirement corresponding to the candidate question text, at least one candidate answer text corresponding to the candidate question text and scoring data of the at least one candidate answer text;
select, based on the scoring data of the at least one candidate answer text, a target answer text from the at least one candidate answer text; and
construct, based on scoring data of the target answer text and a candidate question text corresponding to the target answer text, the training data set of the large reward model, for training the large reward model.

20. A non-transitory computer readable storage medium, storing computer instructions, wherein the computer instructions are caused to enable a computer to perform a method for determining a training data set of a large reward model, the method comprising:
obtaining a candidate question text, and an answer requirement corresponding to the candidate question text;
determining, based on the candidate question text and the answer requirement corresponding to the candidate question text, at least one candidate answer text corresponding to the candidate question text and scoring data of the at least one candidate answer text;
selecting, based on the scoring data of the at least one candidate answer text, a target answer text from the at least one candidate answer text; and
constructing, based on scoring data of the target answer text and a candidate question text corresponding to the target answer text, the training data set of the large reward model, for training the large reward model.
